(19) United States
(12) Patent Application Publication
(10) Pub. No.: US 2017/0194032 A1
(43) Pub. Date: Jul. 6, 2017

(54) PROCESS FOR AUTOMATED VIDEO PRODUCTION

(71) Applicant: Andrew WALWORTH, Stevensville, MD (US)

(72) Inventor: Andrew WALWORTH, Stevensville, MD (US)

(21) Appl. No.: 15/398,513

(22) Filed: Jan. 4, 2017

Related U.S. Application Data
(60) Provisional application No. 62/274,442, filed on Jan. 4, 2016.

(51) Int. Cl. G11B 27/031; G06F 17/28; G06F 17/24; G10L 13/04

(52) U.S. Cl. CPC G11B 27/031; G10L 13/043; G06F 17/28; G06F 17/248

(57) ABSTRACT

Certain embodiments may generally relate to video production. More particularly, certain embodiments of the present invention generally relate to automated video production and editing. A method, in certain embodiments, may include accessing data from a database, importing the data into a dedicated server where the data is entered and organized into a series of data fields, assigning a narrative script template using conditional statements to the series of data fields, transmitting the narrative script template to a video editor, and generating a composite video program with the narrative script template.

### CROSS REFERENCE TO RELATED APPLICATION

This application is related to and claims the priority of U.S. Provisional Patent Application No. 62/274,442, filed Jan. 4, 2016, which is hereby incorporated herein by reference in its entirety.

### FIELD OF THE INVENTION

Certain embodiments may generally relate to video production. More particularly, certain embodiments may generally relate to automated video production and editing.

### BACKGROUND OF THE INVENTION

The video production process may consist of a number of individual tasks that must be completed to produce a final video product. These tasks include but are not limited to collecting and organizing visual and audio source material; scriptwriting; recording voice-over and on-screen narration; designing and generating on-screen graphics; choosing effects and modes of visual transitions (cuts, dissolves, wipes, for example); choosing, recording and cueing background music and sound effects; organizing and editing the materials into a linear video and audio composite; and outputting the final video and audio composite into a recording that is suitably formatted for storage, transmission and viewing. There are known processes that automate steps within the overall production process, but these labor-saving processes still require a sizeable commitment of human intervention to produce a final composite video recording. Further, each step in the process is performed sequentially and in isolation utilizing different tools and software programs, requiring human intervention to move a video project through the various steps in the production process.

Today, a growing number of entities have acquired large databases of personal and/or specific information that they would like to access to create video messages that can be delivered directly to increasingly targeted micro-audiences—even to the level of a single individual recipient. Further, mobile phones, tablets, laptops and computers have incorporated the functionality of video playback machines, while social media platforms (Facebook, Snapchat, Instagram, to name a few) are all increasingly used to upload, view and share video content.

There is a growing pool of personal data and information stored in databases that can be used in the production of videos that communicate on a one-to-one basis to a target audience. At the same time the capacity to receive and consume personalized video content is growing. However, it remains prohibitive in terms of cost, time and effort to create truly unique videos to serve micro-audiences using conventional video production methods.

There is a need, therefore, for an improved method of automating video production to minimize human intervention and cost. Certain embodiments provide a system and method for the automated production, editing and distribution of individualized video programs.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### SUMMARY OF THE INVENTION

A method, in certain embodiments, may include accessing data from a database. The method may also include importing the data into a dedicated server where the data is entered and organized into a series of data fields, assigning a narrative script template using conditional statements to the series of data fields, transmitting the narrative script template to a video editor, and generating a composite video program with the narrative script template. The data may include user-specific information, and the data fields may represent at least one of text, audio, video clips, graphics, music, or a combination thereof. In addition, the method may include synthesizing a narrative script by combining the assigned narrative script template with the data, generating a narration track, wherein the track is an audio file, sending the narration track to the dedicated server where it is entered as a new field, and assigning each data field a position on a video-editing template, and outputting the video program to a user as a video file.

According to certain embodiments, an apparatus may include at least one memory comprising computer program code, and at least one processor. The at least one memory and the computer program code may be configured, with the at least one processor, to cause the apparatus at least to access data from a database, import the data into a dedicated server where the data is entered and organized into a series of data fields, assign a narrative script template using conditional statements to the series of data fields, transmit the narrative script template to a video editor, and generate a composite video program with the narrative script template.

The data may include user-specific information, and the data fields may represent at least one of text, audio, video clips, graphics, music, or a combination thereof. The at least one memory and the computer program code may further be configured, with the at least one processor, to cause the apparatus at least to synthesize a narrative script by combining the assigned narrative script template with the data, generate a narration track, wherein the track is an audio file, send the narration track to the dedicated server where it is entered as a new field, assign each data field a position on a video-editing template, and output the video program to a user as a video file.

According to certain embodiments, a computer program, embodied on a non-transitory computer readable medium, the computer program, when executed by a processor, may cause the processor to access data from a database, import the data into a dedicated server where the data is entered and organized into a series of data fields, assign a narrative script template using conditional statements to the series of data fields, transmit the narrative script template to a video editor, and generate a composite video program with the narrative script template. The data may include user-specific information, and the data fields may represent at least one of text, audio, video clips, graphics, music, or a combination thereof

The computer program, when executed by the processor, may further cause the processor to synthesize a narrative script by combining the assigned narrative script template with the data, generate a narration track, wherein the track is an audio file, send the narration track to the dedicated server where it is entered as a new field, assign each data field a position on a video-editing template, and output the video program to a user as a video file.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 illustrates a simplified block diagram showing the environment for managing software and processes according to certain embodiments.

FIG. 2 illustrates a simplified flow diagram of an Automated Video Production process according to certain embodiments.

FIG. 3 illustrates a simplified chart showing a dedicated database, and examples of the types of data and its organization according to certain embodiments.

FIG. 4(A) illustrates a pool of narrative script templates according to certain embodiments.

FIG. 4(B) illustrates a continuation of the pool of narrative script templates in FIG. 4(A) according to certain embodiments.

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical or structural changes may be made to the invention without departing from the spirit or scope of this disclosure. To avoid detail not necessary to enable those skilled in the art to practice the embodiments described herein, the description may omit certain information known to those skilled in the art. The following detailed description is, therefore, not to be taken in a limiting sense.

### DETAILED DESCRIPTION

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention.

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical or structural changes may be made to the invention without departing from the spirit or scope of this disclosure. To avoid detail not necessary to enable those skilled in the art to practice the embodiments described herein, the description may omit certain information known to those skilled in the art. The following detailed description is, therefore, not to be taken in a limiting sense.

Systems and methods are described for using various tools and procedures used by a software application to generate personalized videos in an automated fashion. The examples described herein are for illustrative purposes only. The systems and methods described herein may be used for many different industries and purposes, including, but not limited to, generating personalized news videos, fantasy sports summary videos, financial reports and the like. In particular, the systems and methods may be used for any industry or purpose where customized video content is needed.

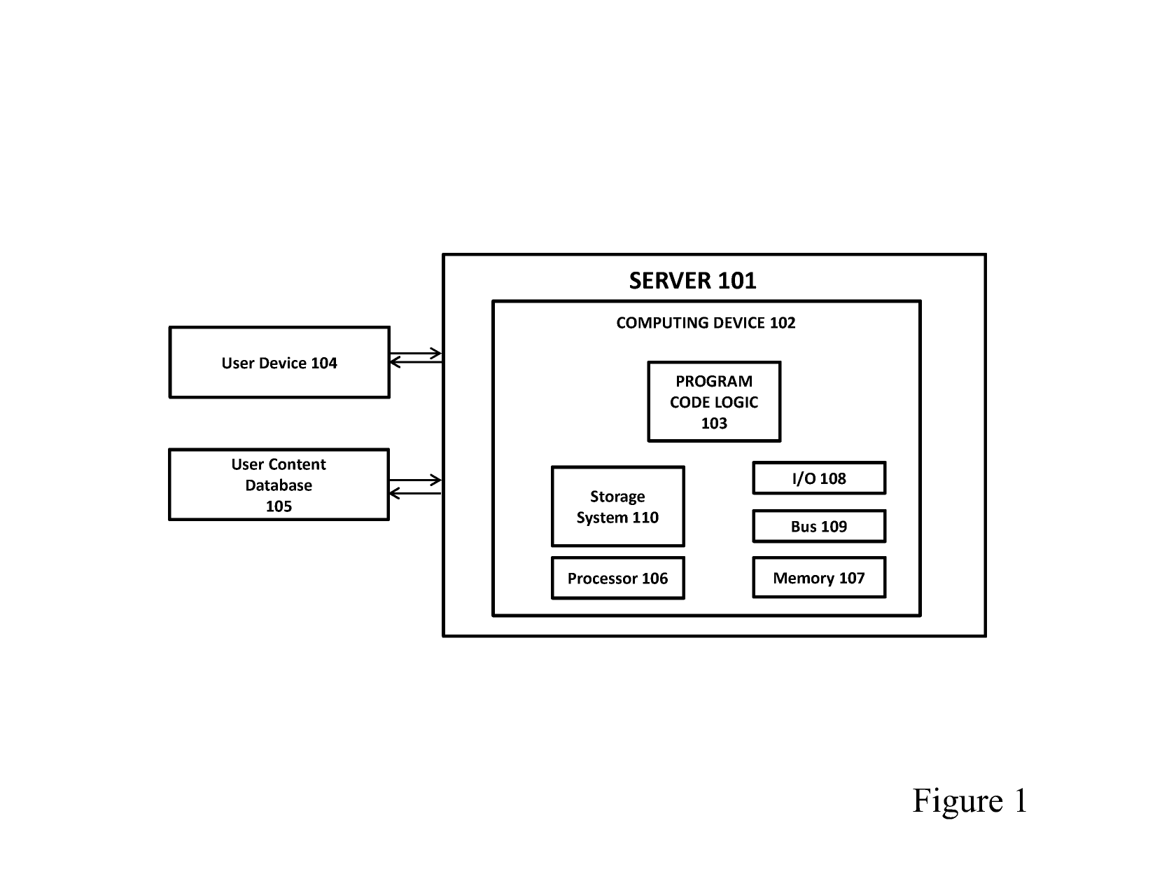

As will be appreciated by one skilled in the art, certain embodiments described herein, including, for example, but not limited to, those shown in FIGS. 1, 2, 3, 4(A), and 4(B), may be embodied as a system, method or computer program product. Accordingly, certain embodiments may take the form of an entirely software embodiment or an embodiment combining software and hardware aspects. Software may include but is not limited to firmware, resident software, microcode, etc. Furthermore, other embodiments can take the form of a computer program product accessible from a computer-usable or computer-readable medium providing program code for use by or in connection with a computer or any instruction execution system, where such software is downloaded from an online store (apple store, android store, and the like).

Any combination of one or more computer usable or computer readable medium(s) may be utilized. For the purposes of this description, a computer-usable or computer readable medium can be any apparatus that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium, More specific examples (a non-exhaustive list) of the computer-readable medium may independently be any suitable storage device, such as a non-transitory computer-readable medium. Suitable types of memory may include, but not limited to: a portable computer diskette; a hard disk drive (HDD), a random access memory (RAM), a read-only memory (ROM); an erasable programmable read-only memory (EPROM or Flash memory); a portable compact disc read-only memory (CDROM); and/or an optical storage device.

The memory may be combined on a single integrated circuit as a processor, or may be separate therefrom. Furthermore, the computer program instructions stored in the memory may be processed by the processor can be any suitable form of computer program code, for example, a compiled or interpreted computer program written in any suitable programming language. The memory or data storage entity is typically internal, but may also be external or a combination thereof, such as in the case when additional memory capacity is obtained from a service provider. The memory may also be fixed or removable.

The computer usable program code (software) may be transmitted using any appropriate transmission media via any conventional network. Computer program code, when executed in hardware, for carrying out operations of certain embodiments may be written in any combination of one or more programming languages, including, but not limited to, an object oriented programming language such as Java, Smalltalk, C++, C# or the like and conventional procedural programming languages, such as the “C” programming language or similar programming languages. Alternatively, certain embodiments may be performed entirely in hardware.

Depending upon the specific embodiment, the program code may be executed entirely on a user's device, partly on the user's device, as a stand-alone software package, partly on the user's device and partly on a remote computer, or entirely on the remote computer or server. In the latter scenario, the remote computer may be connected to the user's device through any type of conventional network. This may include, for example, a local area network (LAN) or a wide area network (WAN), Bluetooth, Wi-Fi, satellite, or cellular network, or the connection may be made to an external computer (for example, through the Internet using an Internet Service Provider).

Certain embodiments may be directed to an automated process for generating playable video that may be customized for an individual or group of individuals. For example, certain embodiments may access information stored in a database and write, produce, edit, and deliver a series of custom videos. Each of the series of custom videos may include unique audio, visual, and text-on-screen content drawn from that database. Other embodiments may utilize database retrieval, natural language generation (NLG) technology, text-to-speech (TTS) technology, automatic video editing, and conventional storage, including cloud-based storage and video file delivery into a seamless and automatic workflow.

FIG. 1 shows an illustrative environment for managing the software and processes according to certain embodiments. Although FIG. 1 illustrates certain elements, certain embodiments may be applicable to other configurations, and configurations involving additional elements, as illustrated and discussed herein. For example, multiple servers, computing devices, user devices, and user content databases may be present, or other elements providing similar functionality. It should be understood that each signal or block in FIGS. 1, 2, 3, 4(A), and 4(B) may be implemented by various means or their combinations, such as hardware, software, firmware, and one or more processors and/or circuitry.

The environment of FIG. 1 may include a server 101 that can perform the processes described herein. The server 101 may be located at any physical place or cloud environment selected by the software application provider. In particular, the server 101 may include a computing device 102. The computing device 102 may include program code logic 103 (one or more software modules) configured to make computing device 102 operable to perform the processes described herein. The implementation of the program code logic 103 may provide an efficient way in which the computing device 102 can receive data specific to a user or group of users from the user content database 105, and send data and content to a user device 104. The program code logic 103 may be contained in more than one computing module.

The user content database 105 may contain data specific to a user or group of users. In certain embodiments, such data may include, for example, user identifying information and user specific content. User identifying information may be any information used to identify the user, such as name, address, email address, phone number, online handle, or identification number. User specific content may vary by the application. For example, a fantasy football application may contain user draft picks, opposing team lineup information, and user selected preferences. In addition, an application utilized for news may contain user news preferences, likes, dislikes, previous news articles accessed, and the like. Further, an application utilized for political content may contain information such as user party affiliation, events attended, and user selected or specific content. In other words, user-specific content may be comprised of any information specific to user likes, dislikes, preferences, selections, and the like.

The program code logic 103 can access information stored in the user content database 105, and import this information (“custom content”) into the memory 107. The user program code logic 103 may also organize the custom content by types of data (text, audio, video clips, graphics, music, and the like) and types of information (personally identifying information, user content categories, and the like). The memory 107 may include local memory employed during actual execution of program code, bulk storage, and cache memories which provide temporary storage of at least some program code in order to reduce the number of times code must be retrieved from bulk storage during execution. In addition, the computing device may include random access memory (RAM) and a read-only memory (ROM). In addition, the computing device 102 may also include a processor 106, the memory 107, an I/O interface 108, and a bus 109.

In certain embodiments, the processor 106 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processor may also be implemented as a single controller, or a plurality of controllers or processors.

According to certain embodiments, the computing device 102 may be in communication with the external I/O device/resource and the storage system 110. For example, the I/O device 108 may include any device that enables an individual to interact with the computing device 102 or any device that enables the computing device 102 to communicate with one or more other computing devices using any type of communications link. The external I/O device/resource may be for example, a handheld device or monitor. In general, the processor 106 may execute the computer program code, which is stored in the memory 107 and/or storage system 110. While executing computer program code, the processor 103 may read and/or write data to/from memory 107, storage system 110, and/or I/O interface 108. The program code, along with the memory may be configured, with the processor, to cause a hardware apparatus such as the computing device 102, to execute and/or perform any of the processes of the various embodiments described herein. The bus 109 may provide a communications link to each of the components in the computing device 102.

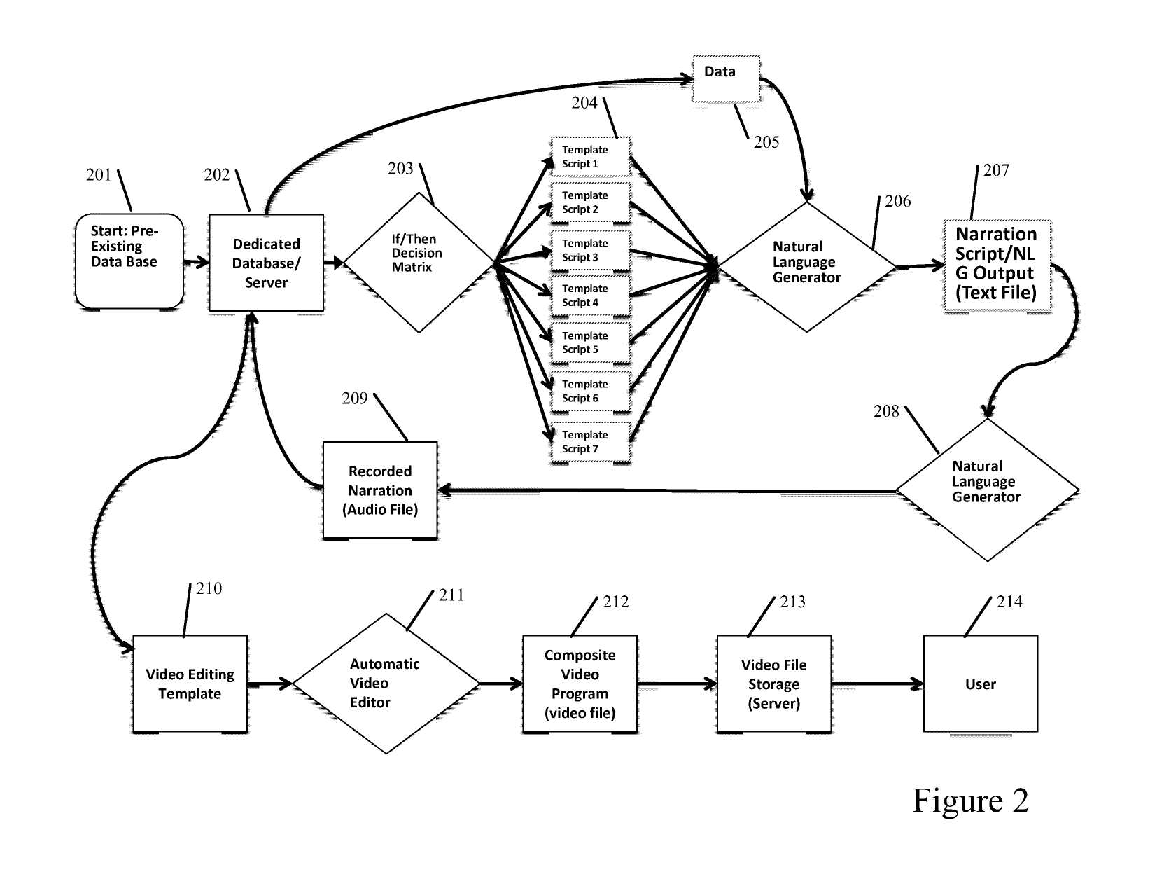

The computer program code may further include a narrating unit that takes the custom content and using conditional statements, assigns a narrative script template. A video may be generated in accordance with the methods of FIG. 2, and may then be delivered to the user device 104 by methods such as E-mail, social media, or other delivery method. In some embodiments, the program code logic 103 may transform the content, e.g., format the content, to ensure that it is compatible with the device of the participant. For example, the program code logic 103 can check the user's device preferences to ensure the device is capable of the message or other media that the system may send.

FIG. 2 is a flowchart showing an automated video production process according to certain embodiments. The automated video production process may include a user content database 105 (“pre-existing database 1”). The software program may examine the data categories and data in the user content database, to find fields represented in the dedicated database 2. Information from the user content database 105 (201), which matches the dedicated database 2 fields, may be copied and saved in the dedicated database 2 of box 202. In addition to data from the pre-existing database 201, the dedicated database 202 may also be pre-loaded with certain visual and audio elements. These may include elements that might be common to all videos produced in this particular grouping, for example, background music and generic background images for graphics, as well as specific elements that might be used in one or several videos, for example, a video of a person or event.

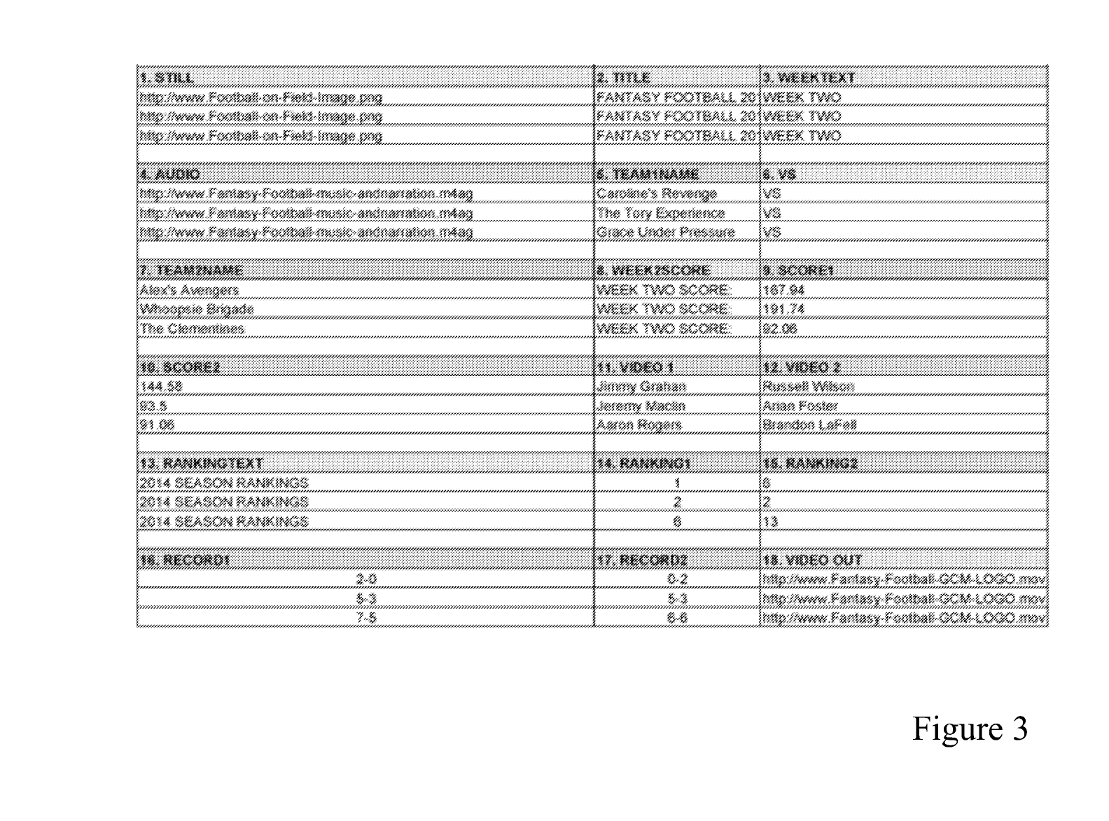

As will be discussed in more detail below, FIG. 3 illustrates a simplified chart of a dedicated database according to certain embodiments. For example, FIG. 3 shows an embodiment that produces videos for a fantasy football match using 18 different data fields in the database; the number of fields could be higher or lower. Certain embodiments are not limited to providing videos for a fantasy football match, however, and may also provide videos for other events or circumstances using more or less than 18 different data fields in the data base.

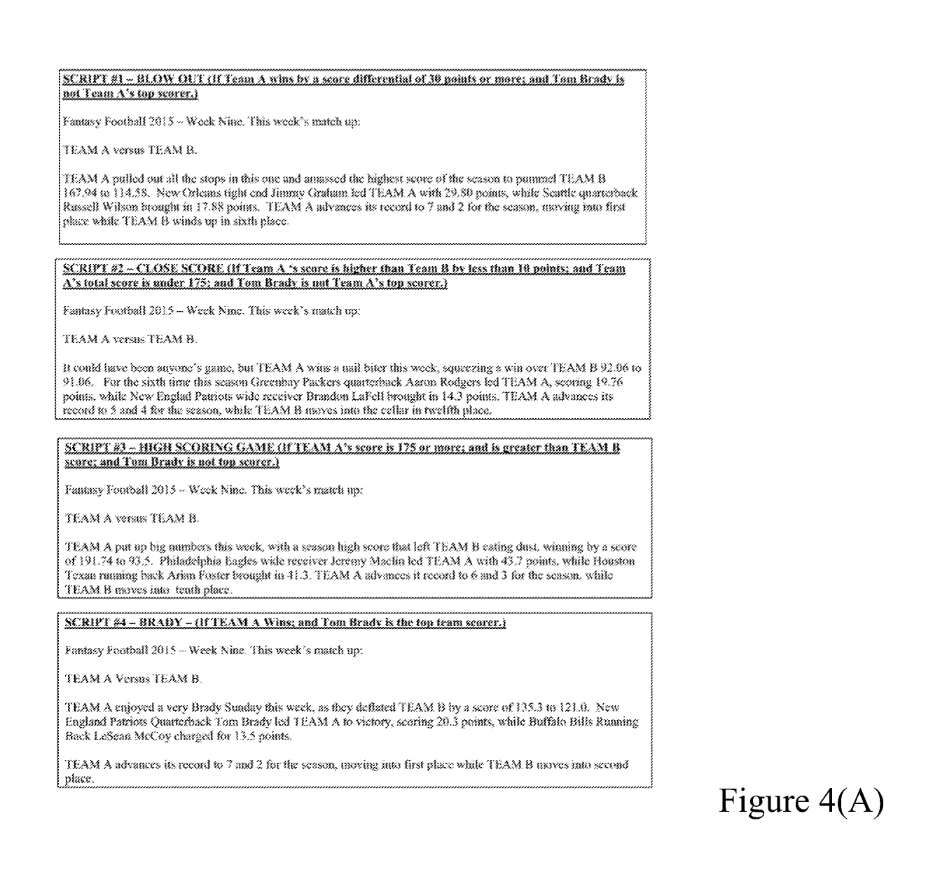

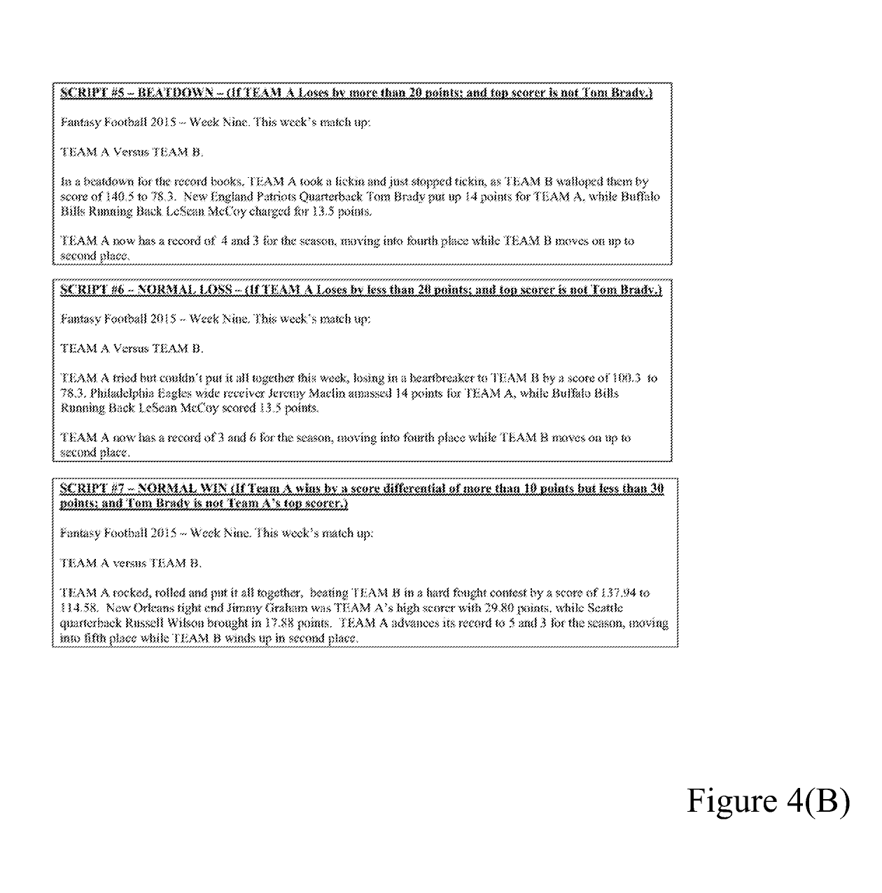

The software in certain embodiments may then use an if/then decision matrix 203 to analyze the data, and based on this analysis, may select from a set of script templates. Examples of the if/then decision matrix and sample scripts are shown in greater detail in FIG. 4(A) and FIG. 4(B). FIG. 4(A) and FIG. 4(B) illustrate seven possible scripts according to certain embodiments that may produce videos for a fantasy football match, but the number of if/then decisions and resulting scripts may be higher or lower. In this instance, some if/then decisions may include whether the subject won or lost the fantasy match, whether it was a close match or not, or whether his/her team included a certain player.

Referring back to FIG. 2, the Natural Language Generation Processor 206, in this instance, may employ a method of script generation called template-based natural language generation. As can be seen in FIG. 4(A) and FIG. 4(B), each script template may include pre-determined sentences that include gaps in the narrative—placeholders for key word and phrases that are to be filled with the specific information from the appropriate data fields from the spreadsheet 202. This data 205—in the form of words and phrases (“linguistic input”), may be inputted directly into a script template 204 by the Natural Language Generator 206. Examples of linguistic input according to certain embodiments may include team names, scores, league rankings, and highest scoring players for the week. By replacing the placeholder phrases with the actual linguistic input, the Natural Language Generator 206 may create a new and unique narrative script 207, which may be a text file.

The text file 207 may automatically be entered into a text-to-speech software program or device 208, which may first analyze the narrative script, and then synthesize an artificial version of a human voice reciting the script. In certain embodiments, this new synthetic voice track may be an audio file 209. The audio file may then be inserted as a new field into the dedicated database 202, filling all fields in the dedicated database 202, after which the system has all the information it needs to begin the video editing process.

When the audio file 209 is loaded into the dedicated database 202, the full complement of data may be transmitted to the automated video editor 210, which may assemble the video and audio elements from the database/server according to an edit template 211, creating a composite video 212. The composite video 212 may be saved to a server 213 for storage and playback. Further, a notification may be sent via E-mail, text, or other web-based communication to a target audience user device, and the composite video 213 may be delivered for viewing by the user 214.

Referring to FIG. 3, there is shown a sample representation of a dedicated database 202 according to certain embodiments. For example, FIG. 3 shows multiple fields with text, audio files, and video files used by the automated video editor. In certain embodiments, such data fields may be assigned a position on a video-editing template. There may be 18 fields of data that define three separate head-to-head weekly matches between fantasy football players. The fields may include numerical information that is represented graphically (scores, points per player, rankings) textual information (opening show title, team names) audio information (background music track, narration track) still photography (backgrounds for graphics, full-screen still photos) recorded video (video clips of players and key plays, for example), and animation (animated avatar, closing credits).

FIG. 4(A) and FIG. 4(B) illustrate a sample pool of narrative script templates according to certain embodiments. For example, in certain embodiments, the sample pool of narrative script templates may include if/then decision matrices representing seven possible script templates for videos describing the results of a weekly fantasy football game. In other embodiments, if/then decision matrices may represent more or less than seven script templates for videos not limited to results of a weekly fantasy football game.

According to certain embodiments, one or more steps of the processes described herein may be implemented on the computer infrastructure of FIG. 1, for example. Each process of the software may represent a module, segment, or portion of code, which comprises one or more executable instructions for implementing the specified logical function's). It should also be noted that, in some alternative implementations, the functions noted in any block of any figure may occur out of the order noted in the figures. For example, two blocks shown in succession may, in fact, be executed substantially concurrently, or the blocks may sometimes be executed in the reverse order, depending upon the functionality involved. Each block of the flow diagram and combination of the flow diagrams can be implemented by special purpose hardware-based systems that perform the specified functions or acts, or combinations of special purpose hardware and computer instructions and/or software, as described above.

Further, the server disclosed herein may include two or more computing devices (e.g., a server cluster) that communicate over any type of communications link, such as a network, a shared memory, or the like, to perform the process described herein. In addition, while performing the processes described herein, one or more computing devices on the server can communicate with one or more other computing devices external to the server using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

According to certain embodiments therefore, it may be possible to provide and/or achieve various advantageous effects and improvements in computer technology over the conventional technology. For instance, according to certain embodiments, it may be possible to save a substantial amount of time and effort required to create individual videos. According to certain embodiments, this may be made possible by, but not necessarily limited to, substituting automated processes, including script-writing, graphics generation, voice-over recording, and editing for those tasks done conventionally by humans. Further, according to other embodiments, it may be possible to greatly reduce the frequency of editorial error, since any data presented in the video may be drawn directly from the database, rather than being copied and key-stroked into a conventional graphics generator by a human operator. By eliminating any intermediate steps while translating the data in the database to the screen, the process may greatly reduce the error rate. This may be equally true for the narrative script, since all data in the script may be drawn directly from the database as well.

According to other embodiments, it may be possible to instantly generate new iterations of the same video to include the latest data from the database. This may allow for near real-time reporting of fast-moving events, for example, financial markets that are in constant flux or live sports events where scores and statistics may constantly be changing during the game. According to certain embodiments, it may also be possible to automatically generate the voiceover narration and the on-screen graphics from the same database. This may assure that the voiceover and the on-screen graphics are in agreement, which is a recurring challenge in conventional production processes.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. While the invention has been described in terms of embodiments, those skilled in the art will recognize that the invention can be practiced with modifications and in the spirit and scope of the appended claims.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

We claim:

1. A method, comprising:
accessing data from a database;
importing the data into a dedicated server where the data is entered and organized into a series of data fields;
assigning a narrative script template using conditional statements to the series of data fields;
transmitting the narrative script template to a video editor; and
generating a composite video program with the narrative script template.

2. The method of claim 1,
wherein the data comprises user-specific information, and
wherein the data fields represent at least one of text, audio, video clips, graphics, music, or a combination thereof.

3. The method of claim 1, further comprising synthesizing a narrative script by combining the assigned narrative script template with the data.

4. The method of claim 1, further comprising generating a narration track, wherein the track is an audio file.

5. The method of claim 4, further comprising sending the narration track to the dedicated server where it is entered as a new field.

6. The method of claim 1, further comprising assigning each data field a position on a video-editing template, and outputting the video program to a user as a video file.

7. An apparatus, comprising:
at least one memory comprising computer program code; and
at least one processor;
wherein the at least one memory and the computer program code are configured, with the at least one processor, to cause the apparatus at least to:
access data from a database;
import the data into a dedicated server where the data is entered and organized into a series of data fields;
assign a narrative script template using conditional statements to the series of data fields;
transmit the narrative script template to a video editor; and
generate a composite video program with the narrative script template.

8. The apparatus of claim 7,
wherein the data comprises user-specific information, and
wherein the data fields represent at least one of text, audio, video clips, graphics, music, or a combination thereof.

9. The apparatus of claim 7, wherein the at least one memory and the computer program code are further configured, with the at least one processor, to cause the apparatus at least to synthesize a narrative script by combining the assigned narrative script template with the data.

10. The apparatus of claim 7, wherein the at least one memory and the computer program code are further configured, with the at least one processor, to cause the apparatus at least to generate a narration track, wherein the track is an audio file.

11. The apparatus of claim 10, wherein the at least one memory and the computer program code are further configured, with the at least one processor, to cause the apparatus at least to send the narration track to the dedicated server where it is entered as a new field.

12. The apparatus of claim 7, wherein the at least one memory and the computer program code are further configured, with the at least one processor, to cause the apparatus at least to assign each data field a position on a video-editing template, and output the video program to a user as a video file.

13. A computer program, embodied on a non-transitory computer readable medium, the computer program, when executed by a processor, causes the processor to:
access data from a database;
import the data into a dedicated server where the data is entered and organized into a series of data fields;
assign a narrative script template using conditional statements to the series of data fields;
transmit the narrative script template to a video editor; and
generate a composite video program with the narrative script template.

14. The computer program of claim 13,
wherein the data comprises user-specific information, and
wherein the data fields represent at least one of text, audio, video clips, graphics, music, or a combination thereof.

15. The computer program of claim 13, wherein the computer program, when executed by the processor, further causes the processor to synthesize a narrative script by combining the assigned narrative script template with the data.

16. The computer program of claim 13, wherein the computer program, when executed by the processor, further causes the processor to generate a narration track, wherein the track is an audio file.

17. The computer program of claim 16, wherein the computer program, when executed by the processor, further causes the processor to send the narration track to the dedicated server where it is entered as a new field.

18. The computer program of claim 13, wherein the computer program, when executed by the processor, further causes the processor to assign each data field a position on a video-editing template, and output the video program to a user as a video file.
